(19) United States
(12) Patent Application Publication
(10) Pub. No.: US 2001/0014919 A1
(43) Pub. Date: Aug. 16, 2001

(54) Method for dialing from computer applications

(76) Inventor: Amatzia Tzirin, Rehovot (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/817,243

(22) Filed: Mar. 27, 2001

Related U.S. Application Data
(63) Continuation-in-part of application No. PCT/IL99/00517, filed on Sep. 28, 1999.
(60) Provisional application No. 60/102,068, filed on Sep. 28, 1998.

(51) Int. Cl. H04L 12/66; G06F 9/00; G06F 9/46

(52) U.S. Cl. 709/328; 379/900; 370/352

(57) ABSTRACT

A method is provided for computer users to dial all numbers appearing in any environmental application (raster or vector) store the number automatically in any SQL engine database. The numbers are sent in an automatic fashion to the appropriate dialer. The method includes identifying each digit of a plurality of digits appearing on the user's screen, translating the digits into data string mode and transferring the data string mode to the dialing unit for dialing. The data string mode is storable in a SQL engine database.

### RELATED APPLICATIONS

This application is a continuation in part application of PCT Application No: PCT/IL99/00517, filed Sep. 28, 1999, which is hereby incorporated by reference.

### FIELD AND BACKGROUND OF THE INVENTION

The present invention relates to dialing directly from computer applications and specifically for dialing a sequence of digits from any environmental application.

At present, computer users wishing to dial from their computer need to utilize specially programmed applications incorporating a special dialing unit. When working under a different platform or with a different application not having a dialer as part of the application, the user has to go outside the working application to dial.

### SUMMARY OF THE INVENTION

An object of the present invention is to provide computer users with an automated and effective mode from which to dial all numbers appearing on the user's screen. The uniqueness of the program allows the user to dial all numbers appearing in any environmental application (raster or vector) in Windows and store the number automatically in any SQL engine database. The numbers are sent in an automatic fashion to the appropriate dialer meaning that the user does not have to retype any digits, and therefore can dial the string digit in an efficient and convenient manner.

The program identifies and translates every event of single or multiple digits appearing on the user's screen. The process is activated through demarcation of the string event using devices such as the mouse or keyboard.

The program is designed to recognize and differentiate between the raster and vector formats. Once identification is completed the program converts the digit event into a string mode. The digit event is then connected to an output device such as a modem or fax.

The program allows the user to store all digit events in a separate database. The database is able to incorporate additional demographic information, which the user deems relevant.

The program is activated automatically when Windows 95 is loaded and remains in a TSR (terminated and stay resident) function. The user can load and unload the program at any time by depressing the appropriate icon. The icon appears automatically when Windows is loaded.

There is thus provided a method for dialing from an application run on a computer having a dialing unit connected thereto. The method includes identifying each digit of a plurality of digits appearing on the user's screen, translating the digits into data string mode and transferring the data string mode to the dialing unit for dialing. The data string mode is storable in a SQL engine database.

### BRIEF DESCRIPTION OF THE DRAWINGS

The present invention will be understood and appreciated more fully from the following detailed description taken in conjunction with the appended drawings in which:

FIGS. 1A/1B is a flow chart illustration of the operation of the program.

### DETAILED DESCRIPTION OF THE PRESENT INVENTION

According to a preferred embodiment of the present invention, computer users are provided with an automated and effective mode from which to dial all numbers appearing on the user's screen. All numbers appearing in any environmental application, whether raster or vector which appear in any Windows or other platform can be dialed. The numbers can be stored automatically in any SQL engine database.

The program is based on four continuous processes or modules, having an infrastructure, as follows:

1. The Initialize Module.

Analysis of environment

Coded escape sequence

Hot key marking/unmarking

Video read/write buffers

2. The Decoder Module.

Central algorithm

Component analysis

Digit recognition

Determination of number of digits

Sorting and grouping

Multiple digit events

Unrecognized digit event

3. The Transfer Module.

Recognition of data

Transfer of data

Temporary buffer

4. The Storage Module.

SQL database engine

Extension fields

Access to the dialer

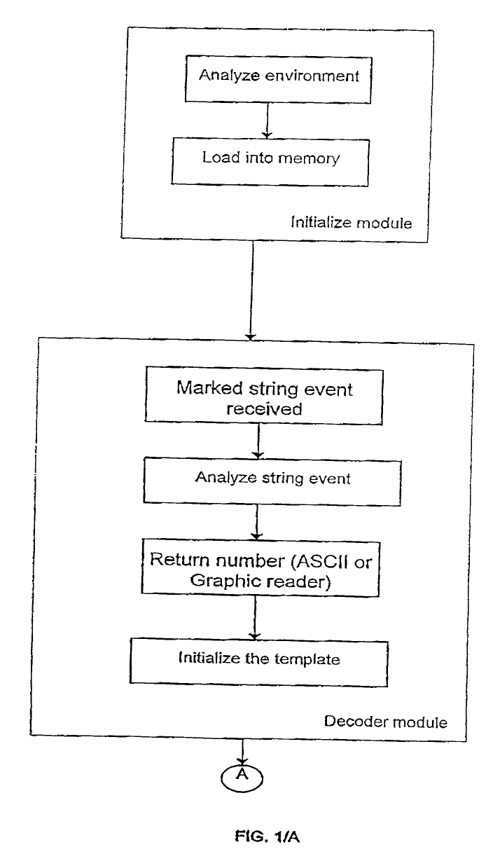

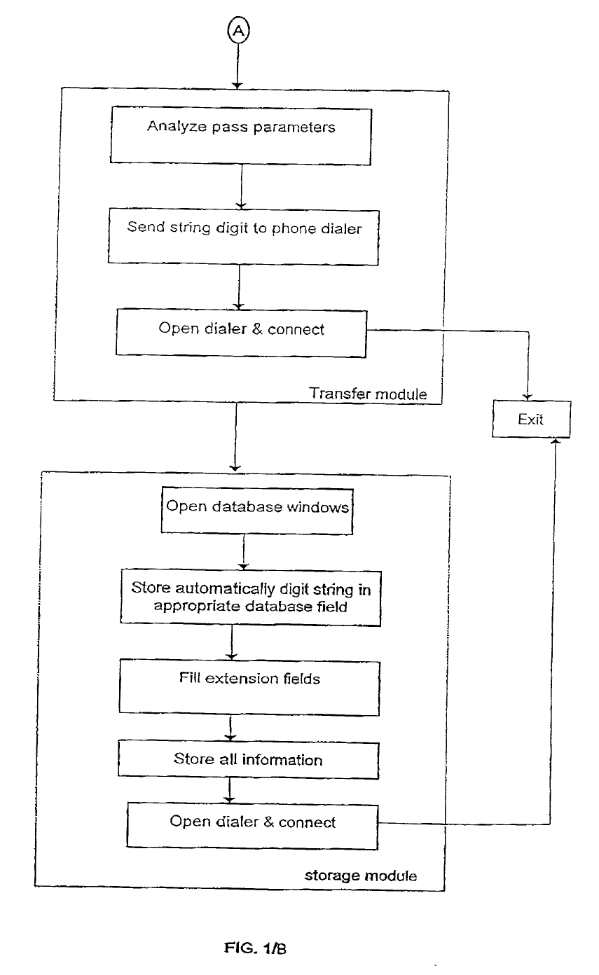

Reference is now made to FIG. 1 which is a flow chart illustration of the operation of each of the modules.

1. Initialize Module

The initialize module consists of programs, which analyze the environment of the digit event by using coded escape sequence to identify the existing format of the digit event.

The initialize module also contains functions that activate and detect the hot key to be used in marking and unmarking the digit event.

Finally, present in the initialize module are the functions that register the video read/write buffers.

2. Decoder Module

The decoder module is the heart and soul of the program. Included in this module is the central algorithm that transfers the digit event to the appropriate template.

The goal of the algorithm is to separate a chosen digit event from its existing environment and to divide the digit event into specific regions. Each region contains an individual digit.

The stages of the algorithm include:

component analysis

determining the number of digits

sorting and grouping of the digit event

determining unexpected or unusual formats of the digit events

In order to sequence the digit event and approximate the number of digit events the algorithm utilizes a joint method of statistical and structural techniques. The statistical and structural methodology relies upon digit event recognition.

The process of digit event recognition is based on row-separation of the digit event.

The number of rows in each unit is contiguous and decreases by one with each transition.

A smaller row-separation allows for a clearer analysis of the digit event whereas a larger row-separation makes it more difficult for the algorithm to group and estimate the length of the digit event.

Multiple digit events located in close proximity can be translated as a single digit event in early stages of the algorithm. In later stages they are separated and recognized in their correct form.

The process of digit event recognition results in the algorithm separating is the number into one of ten specific groups. If the number is not able to be recognized and grouped then it is not accepted as a digit event.

The algorithm uses parameters in a variety of settings. The result of this process is the conclusion of the correct number of digit events. If a number has not been marked or if a number has been marked incorrectly then the algorithm will not accept the transaction. A signal will appear on the screen to indicate the mistake to the user.

3. Transfer Module

The stages of the transfer module include the following:

recognition of the data

transferring the data

utilizing a temporary buffer

The transfer module begins by recognizing the output data that has resulted from the decoder module. This process of recognition is achieved by using pass parameters that are structurally constructed to communicate with the parameters of the decoder module.

The data result (string digit event) is transferred to the appropriate existing dialer in Windows. The data result must be situated correctly and match the template in the dialer pop-up in Windows.

The transfer module uses a temporary buffer to store the actual string digit event while the data is being transferred to the dialer. Following completion of the transfer of the data result the temporary buffer is initialized to null and able to receive a new data result.

4. Storage Module

The storage module enables the user to store any string digit event, which was produced in the decoder module.

The module is comprised of any SQL database engine, which transfers the string digit event info a format of database with extension fields. The extended fields provide the user with the option to add further information relevant to the string digit event.

The database is an open database. The user can sort and index the information according to their individual needs.

The database provides an option for the user to access and activate the dialer directly.

In an alternative embodiment, in addition to identifying the numbers appearing on the users screen in environmental applications, the program is also able to identify all texts and strings including names, addresses, phone numbers, e-mail addresses, web sites, and the like in all environmental applications.

Recognized Texts

Identification of the string or text is accomplished by depressing the right button of the mouse or by use of specific buttons on the keyboard. The user must highlight the desired text, depress the mouse or the required buttons on the keyboard, and if the text is recognized by the database of the program click, the user will automatically be given two options:

a. connection to the existing demographic database where the user can locate personal details of individuals whose records are stored; or

b. automatic dialing of an individuals telephone number, fax number, e-mail, web site, and the like.

The numbers and addresses of the individual (who is known and recognized in the demographic database) automatically appear on the users screen. The user has the option of choosing any or all numbers or addresses he wishes to use and the program click automatically carries out the desired activity.

Non-Recognized Texts

If the text or string is not recognized by the program click, it is because there is no record or file connecting the text to an individual in the demographic database. In this case, after the user highlights the desired text and depresses the mouse or the necessary buttons on the keyboard the program click can automatically connect the user to the demographic database to enable the user to open a new record. The user then fills in the necessary demographic information on the individual. If the user highlights a telephone number, fax number, or e-mail address that is not recognized in the database the program click allows the user to connect to the demographic database to open a new record or to immediately dial the number or send a document to the e-mail address without entering the database and without creating a file in the database.

Access to the Internet

When working in any environment including browsing in the internet, the user can highlight a desired text or string, activate the program click, and automatically search the internet for all relevant data. The data then appears on the user's screen allowing the user to gather information from the internet while remaining in his current working environment. The program click, when browsing the internet, uses a search engine determined by the properties environment of the click program.

E-MAIL Attachment Files

When the user is working in any word processing environment and highlights a desired text or string and activates the program click, a text can be e-mailed to a person. The program click then allows the user the option of sending the text as an attach file or of adding an additional attach file to be e-mailed.

History Log Files

All transactions carried out through the program click such as calling a person on the telephone, faxing a text, e-mailing a text, and the like are stored in history log files.

Personal and Central Databases

The program click allows an individual user to work in his own database meaning all recognized texts and strings will be processed through his personal database. Furthermore, the program click can operate from a central database.

The central database joins records and information used by a number of users.

The user can direct the program click to recognize a text either through his personal database or that of a central database.

The program click can be operated manually. The user depresses the window taskbar of the program click which is on his screen. The user then enters the appropriate information such as a name, phone number, fax number, or e-mail address and the corresponding personal record will appear from the database.

It will be appreciated by persons skilled in the art that the present invention is not limited by what has been particularly shown and described hereinabove.

1. A method for dialing from an application run on a computer, said computer having a dialing unit connected thereto, said method comprising the steps of:
identifying each digit of a plurality of digits appearing on an user's screen;
translating each of said plurality of digits into data string mode; and
transferring the data string mode to the dialing unit for dialing.

2. The method according to claim 1 and further comprising the step of storing said data string mode in a SQL engine database.

3. The method according to claim 1 wherein said step of identifying includes the step of activating and detecting the hot key to be used in marking and unmarking the digit event.

4. The method according to claim 1 wherein said step of identifying includes the step of registering the video read/write buffers.

5. The method according to claim 1 wherein said step of translating includes the steps of
determining the number of said plurality of digits;
sorting and grouping of the each of said plurality of digits; and
determining unexpected or unusual formats of the each of said plurality of digits.

6. The method according to claim 1 wherein said step of transferring includes the steps of
recognition of said data string mode;
transferring said data string mode; and
utilizing a temporary buffer for storage of said data string mode.

7. A method for dialing from an application run on a computer, said computer having a dialing unit connected thereto, said method comprising the steps of:
highlighting at least one string of alphanumeric text;
comparing said at least one string of alphanumeric text with data stored in a database; and
if said at least one string of alphanumeric text matches data in said database;
transferring the string of alphanumeric text to the dialing unit to initiate dialing.

8. The method according to claim 7, wherein if said at least one string of alphanumeric text does not match data in said database, further comprising the step of:
opening a record in said database; and
allowing the user to enter dialing data into said database.

9. The method according to claim 7, wherein said database is accessible via the Internet.

10. The method according to claim 7, and further comprising the step of:
attaching a file for sending to the addressee being dialed.

11. The method according to claim 7, wherein said database is locally located on said user computer or remotely located.
